(19) United States
(12) Patent Application Publication
(10) Pub. No.: US 2025/0356046 A1
(43) Pub. Date: Nov. 20, 2025

(54) QUERYABLE ENCRYPTION RANGE SUPPORT

(71) Applicant: MongoDB, Inc., New York, NY (US)

(72) Inventors: Tarik Moataz, Brooklyn, NY (US); Seny Kamara, New York, NY (US)

(73) Assignee: MongoDB, Inc., New York, NY (US)

(21) Appl. No.: 19/209,260

(22) Filed: May 15, 2025

Related U.S. Application Data
(60) Provisional application No. 63/648,560, filed on May 16, 2024.

(51) Int. Cl. G06F 21/62; G06F 16/2452; G06F 21/60

(52) U.S. Cl. CPC G06F 21/6227; G06F 16/2452; G06F 21/602

(57) ABSTRACT

Described herein are database systems that execute range queries on encrypted data. Provided is a numerical encoding scheme provides a set of order-preserving functions that maps all numerical data types supported by the database systems to a compact set of positive integers representative of the range query. Stored encrypted data may also be represented as positive integers. The positive integers from the range query may then be used to execute a set of equality queries on the stored encrypted data. Also provided is a range hypergraph supporting range queries to be executed on the encrypted data with high-throughput and without high amounts of storage overhead. Additionally, a hypergraph-friendly compaction protocol may be performed with padded inputs, in order to reduce leakage for range queries.

### CROSS_REFERENCE TO RELATED APPLICATIONS

This application claims the benefit under 35 U.S.C. § 119(e) of U.S. Provisional Application Ser. No. 63/648,560, filed May 16, 2024, under Attorney Docket No. T2034.70084US00, and entitled “QUERYABLE ENCRYPTION RANGE SUPPORT,” which is hereby incorporated herein by reference in its entirety.

### BACKGROUND

Implementing end-to-end encryption poses many challenges in the data management and database spaces.

### SUMMARY

According to aspects of the disclosure, there is provided a database system comprising: at least one processor operatively connected to a memory, the at least one processor when executing configured to: manage a database client, the database client configured to: accept a range query; convert the range query into one or more equality queries; and transmit the one or more equality queries to a distributed database; and manage the distributed database, the distributed database configured to: store encryption of plaintext data; process the one or more equality queries against the encryption of the plaintext data, such that the one or more equality queries operate on encrypted data; retrieve the encrypted data; and provide a result of the range query to the database client, wherein: the database client is configured to convert the range query into the one or more equality queries by compactly mapping input numerical data having any numerical data type supported by the distributed database to output positive integers with order preserved relative to the input numerical data; and converting the range query into the one or more equality queries comprises converting the range query into the one or more equality queries using a range hypergraph arranged with at least one of a sparsity factor or a trimming factor.

According to aspects of the disclosure, there is provided at least one non-transitory computer-readable storage medium having instructions encoded thereon that, when executed by at least one processor, cause the at least one processor to perform a method for managing a database system, the method comprising: managing a database client, comprising: accepting a range query; converting the range query into one or more equality queries; and transmitting the one or more equality queries to a distributed database; and managing the distributed database, comprising: storing encryption of plaintext data; processing the one or more equality queries against the encryption of the plaintext data, such that the one or more equality queries operate on encrypted data; retrieving the encrypted data; and providing a result of the range query to the database client, wherein: converting the range query into the one or more equality queries comprises compactly mapping input numerical data having any numerical data type supported by the distributed database to output positive integers with order preserved relative to the input numerical data; and converting the range query into the one or more equality queries comprises converting the range query into the one or more equality queries using a range hypergraph arranged with at least one of a sparsity factor or a trimming factor.

According to aspects of the disclosure, there is provided a computer-implemented method for managing a database system, the method comprising: managing a database client, comprising: accepting a range query; converting the range query into one or more equality queries; and transmitting the one or more equality queries to a distributed database; and managing the distributed database, comprising: storing encryption of plaintext data; processing the one or more equality queries against the encryption of the plaintext data, such that the one or more equality queries operate on encrypted data; retrieving the encrypted data; and providing a result of the range query to the database client, converting the range query into the one or more equality queries comprises compactly mapping input numerical data having any numerical data type supported by the distributed database to output positive integers with order preserved relative to the input numerical data; and converting the range query into the one or more equality queries comprises converting the range query into the one or more equality queries using a range hypergraph arranged with at least one of a sparsity factor or a trimming factor.

In some embodiments, converting the range query into the one or more equality queries comprises: in response to determining that the input numerical data has a data type other than a first data type, encoding the input numerical data as data of the first data type; and transforming the encoded data of the first data type into the one or more equality queries, the one or more equality queries representative of the input numerical data.

In some embodiments, the range hypergraph comprises a skip level hypergraph including a first plurality of nodes and excluding a second plurality of nodes; the included first plurality of nodes of the skip level hypergraph are arranged by the at least one of the sparsity factor or the trimming factor.

In some embodiments, the skip level hypergraph is arranged with the sparsity factor and the trimming factor; and the included first plurality of nodes of the skip level hypergraph comprises nodes of depths that are: a multiple of the sparsity factor; and bottom depths defined by the trimming factor.

In some embodiments, including the first plurality of nodes and excluding the second plurality of nodes in the skip level hypergraph reduces competition between nodes in the skip level hypergraph.

In some embodiments, storing the encryption of the plaintext data comprises performing a compaction protocol on the stored encryption of the plaintext data; and performing the compaction protocol comprises padding an input with dummy data.

In some embodiments, padding the input with the dummy data is configured to reduce leakage for range queries.

### BRIEF DESCRIPTION OF DRAWINGS

FIG. 1 is an example diagram of a database system providing support for range queries on encrypted data, according to some embodiments.

FIG. 2 is an example block diagram of a special purpose computer system that can be configured to execute the functions discussed herein.

FIG. 3 shows exemplary pseudocode for a hypergraph for database systems, according to some embodiments.

FIG. 4 shows exemplary pseudocode for an encoding algorithm for database systems, according to some embodiments.

FIG. 5 shows exemplary pseudocode for a range multi-map encryption scheme for database systems, according to some embodiments.

FIGS. 6, 7, and 8 show exemplary pseudocode for a document database encryption scheme for database systems, according to some embodiments.

### DETAILED DESCRIPTION

Described herein are database systems that execute range queries on encrypted data. Provided is a numerical encoding scheme provides a set of order-preserving functions that maps all numerical data types supported by the database systems to a compact set of positive integers representative of the range query. Stored encrypted data may also be represented as positive integers. The positive integers from the range query may then be used to execute a set of equality queries on the stored encrypted data. Also provided is a range hypergraph supporting range queries to be executed on the encrypted data with high-throughput and without high amounts of storage overhead. Additionally, a hypergraph-friendly compaction protocol may be performed with padded inputs, in order to reduce leakage for range queries.

Aspects of the disclosure relate to numerical encodings. In some embodiments, numerical encodings described herein may provide a set of order-preserving functions that map various numerical data types to a set of positive integers. The mapping to the set of positive integers may be compact, such that the representation of the resulting positive integers is not too large. For example, an output of the numerical encoding may maintain a same or similar (e.g., within 10%) number of bits as the input. Numerical encodings described herein may enable database systems to handle encrypted range queries over all numerical types of the set of different numerical types that a database system supports. For example, when a query is accepted, before converting a range query into a set of equality or point queries, if the range query is of a data type other than a first data type (e.g., other than positive values of int or natural numbers), the data type may be first converted to the first data type (e.g., converted from floating point to positive values of int).

ERX may provide a framework configured to operate on natural numbers, (e.g., {0, 1, . . . , N}) and may have an upper bound (e.g., 2³²). As discussed above, queryable encryption for ranges as described herein may support data types that are not necessarily natural numbers, such as floating-point formats (e.g., binary64 or decimal128). To support these data types, numerical encodings described herein may map floating-point numbers to natural numbers and may have to have additional properties. For example, the numerical encoding may be order-preserving, compact and/or efficient.

In some embodiments, an order-preserving numerical encoding may be configured to map inputs to two natural numbers that preserve the order of the inputs. As merely one example, with inputs of 2.0001 and 2.0002, an order-preserving numerical encoding may these inputs to two natural numbers that preserve the order, such as, respectively, 16 and 19. An efficient numerical encoding may be configured to perform mappings in a reasonable amount of time. A compact numerical encoding may be configured to perform mappings that do not substantially increase the size of any inputs to the numerical encoding, do not increase the size of the inputs over a particular size, and/or do not increase the size more than a certain multiple. As merely one example, a compact numerical encoding may use 64 bits to represent an output of a binary64 encoding or may use 128 bits to represent an output of a decimal128 encoding. The output of the numerical encoding may be a string representation.

Furthermore, the ERX framework may use a range hypergraph. The range hypergraph may be arranged as an object that maps a range to a set of vertices and a vertex to a set of edges. The ERX framework may use the range hypergraph to transform range queries into equality queries.

In some embodiments, an encrypted range query may be transformed to a set of one or more encrypted equality queries using the ERX framework. ERX may be parameterized with a range hypergraph, as discussed herein. As noted above, the set of equality queries may be generated using the converted data type. A system providing queryable encryption for ranges may convert the queries using a range hypergraph, examples of which are described herein. For example, one particular range hypergraph may account for various attributes or performance targets for queryable encryption. For example, the hypergraph may account for attributes of efficiency (e.g., reducing client computation, storage overhead, communication overhead, or other efficiency attributes), as well as other attributes related to concurrency and security. In some embodiments, the hypergraph may resemble a tree but may be formed using parameters such as a sparsity factor and a trimming factor that modify the tree. For example, a sparsity factor may “thin” the tree by excluding nodes at depths of the tree other than those that are multiples of the sparsity factor. The trimming factor may “trim” the tree by excluding nodes other than nodes at bottom depths determined by the trimming factor.

In some embodiments, a compaction may be a protocol between the client and a database (such as a MongoDB server). When the compaction is performed, the size of the encrypted state collection (ESC) and the encrypted compaction collection (EcoC) in queryable encryption may be reduced substantially.

In various embodiments, a compaction protocol may be used because the size of both ESC and EcoC may grow “linearly” with the number of insertions and/or updates. Systems described herein may be improved to allow database customers the ability to reclaim storage at certain points in time.

In some embodiments, a reduced leakage compaction protocol is provided. As noted, a compaction protocol is an important process for encrypted databases, because compaction shrinks encrypted structures, thereby improving efficiency. However, conventional compaction protocols may leak certain information.

The compaction protocols described herein may reduce leakage from encrypted range queries by inserting dummy values during compaction. When executing range queries on encrypted data, if not using such an improved compaction protocol, the range queries may leak distance information to bad actors. That is, the result of the range query might provide distance information indicating how far apart certain values are. Thus, even if the bad actor cannot learn what the values are, they might be able to learn that the values are close to each other. Thus, compaction protocols present security vulnerabilities in a system supporting range queries on encrypted data. The improved compaction protocols described herein reduce leakage of this distance information by padding the data with dummy values, which obscures the true distance between values. Because dummy values are inserted between existing values, bad actors may not be able to obtain the true distance between the existing values, prevent bad actors from exploiting the security vulnerabilities presented by range queries executed on encrypted data.

Accordingly, provided herein is an improved compaction protocol. The improved compaction protocol may be similar to other compaction protocol which may be used for equality queryable encryption. However, the improved compaction protocol for queryable encryption of ranges may be configured to inserts “dummy” documents to the ESC. Dummy documents may be inserted to improve security. In various embodiments, the number of dummy documents that are inserted may depend on a configuration of a range hypergraph, and/or the distribution of insertions and/or updates.

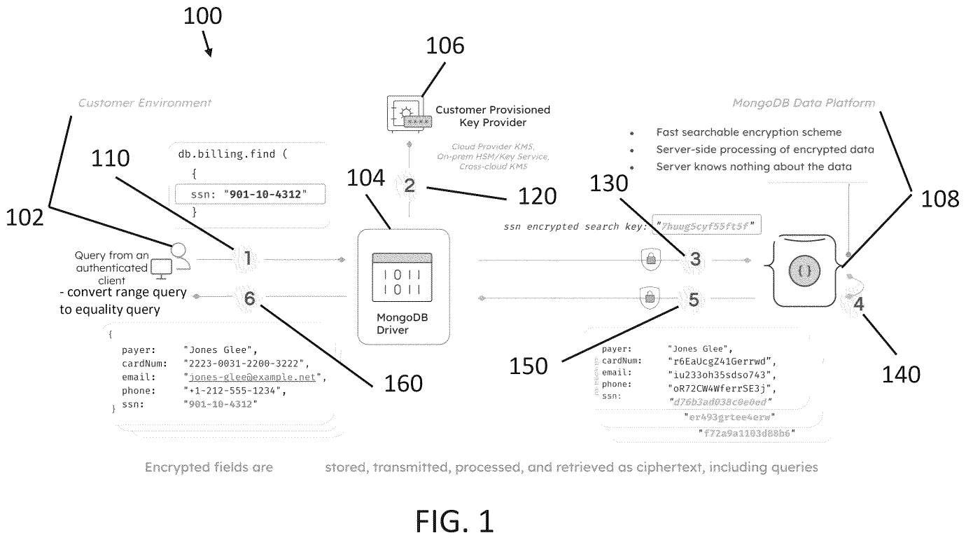

FIG. 1 is an example diagram of a database system 100 providing support for range queries on encrypted data, and a related process of performing range queries on encrypted data. Database system 100 includes a client environment 102 (e.g., a customer environment), a driver 104 (e.g., a MongoDB driver), a client key provider 106 (e.g., a customer provision key provider), and a data platform 108 (e.g., a MongoDB data platform). Queries may be executed on encrypted data in the database system 100 using a series of steps 110, 120, 130, 140, 150, and 160. At step 110, a query is received from an authenticated client. At step 120, a key is provided for encrypting and/or decrypting data (e.g., the query of step 110). At step 130, an encrypted query is transmitted to the data platform 108. At step 140, the query is executed on encrypted data at the data platform 108. At step 150, an encrypted result of the query is provided. At step 160 the encrypted result is decrypted.

As illustrated in FIG. 1, step 110 of receiving a query from a client may include a step of converting a range query into an equality query, as described herein. Though FIG. 1 illustrates an equality query for a social security number (SSN), it should be appreciated that a similar process as illustrated in FIG. 1 may be executed for performing range queries on encrypted data by including the step of converting a range query into an equality query when the range query is received.

Aspects of the disclosure relate to hypergraphs. In some embodiments, a hypergraph is provided for ranges. The range hypergraph, and its accompanying algorithms, may, over an interval of integers, have some of all of the following properties: (1) can be represented compactly; (2) have an efficient algorithms to compute minimum covers (3) have an efficient algorithm to compute the edges that contain a given vertex (4) provides high throughput constructions when used as a basis for encrypted range multi-maps. Hypergraphs described herein may enable database systems to support range queries over encrypted data with high-throughput and without high amounts of storage overhead.

Aspects of the disclosure may relate to compaction. For example, the disclosure may provide hypergraph-friendly compaction. Such compaction may have a compaction algorithm for one of queryable encryption's auxiliary structures that provides less leakage. Reduced leakage may be important in environments where the structure is used in the context of range queries. Compaction described herein may be hypergraph-friendly and may provide systems with range queries over queryable encryption do not leak too much.

Aspects of the disclosure relate an extended implementation of the OST document database encryption scheme that processes range queries. In some embodiments, there is provided a hypergraph-friendly encrypted multi-map. A range multi-map encryption scheme Ω_{R} may be provided using hypergraph compiler. The compiler may use a hypergraph scheme Γ and a standard multi-map encryption scheme Σ_{MM} and produce a range multi-map encryption scheme Ω_{R}. The multi-map encryption scheme used may be referred to as the base scheme and to the range multi-map encryption produced may be referred to as the resulting scheme.

In some embodiments, there is provided a stateless base scheme Δ that is a variant of the Ω construction and it may be better suited for use with the hypergraph compiler. The scheme may from Ω in the following ways. First, in addition to supporting a Put operation it also supports a BatchPut operation that takes as input a set of labels L=( [symbol] 1, . . . , [symbol] n) and a tuple v and inserts ( [symbol] i, v)i∈[n] into the structure. The second difference is in its compaction algorithm provided below.

Aspects of the disclosure relate to compaction. While Ω may be used as a base scheme for the hypergraph compiler, it may result in an encrypted range scheme that has an undesirable leakage profile. According to some embodiments, Ω's compaction protocol may leak the rank and the number of unique label/value/partition triplets that were added since the last compaction. Furthermore, when Ω is used as a building block in OST, an Ω-level label corresponds to a value associated with a database-level field f. It follows then that, after an Ω-level compaction, a multi-snapshot adversary may learn—if the number of partitions is 1—the number of unique values associated with f. This leakage comes from the number of anchors compaction creates.

If a database system were to use Ω as a building block in OST, Ω's compaction leakage may result in worse OST-level compaction leakage. For example, it may reveal more than the number of unique values associated with f. This is due to the hypergraph compiler. In some embodiments, to store a label/tuple pair ( [symbol] , v) in the range multi-map (the OST multi-map in our case), [symbol] is first mapped to a set of edges {e1, . . . , em} and the pairs in (e1, v), . . . , (en, v) are stored in the point multi-map (the Ω multi-map in our case). Here, an edge may comprise an encoding of the numerical label [symbol] . For most encodings, it may be the case that two distinct range-level labels may produce an overlapping set of edges. Furthermore, the closer that these range-level labels are, the larger the overlap may be. However, if the compaction leakage of the point multi-map reveals the number of unique labels inserted since the last compaction and if the point-level labels are edges, then it may reveal the number of unique edges inserted since the last compaction, which may be correlated with how close the range-level labels are.

Aspects of the disclosure reduce leakage. For example, a compaction protocol of the hypergraph-friendly scheme Δ described herein may take as input an additional parameter δ∈[0, 1] that controls how much the scheme leaks. The leakage may be reduced by inserting dummy anchors so that the total number of anchors (both dummy and real) does not reveal the exact number of edges. If δ=0, the compaction leakage is the same as Ω's. If δ=1, the number of anchors is equal to the number of labels stored since the last compaction. Note however that a higher value of δ leads to more storage overhead. In some embodiments, systems may therefore use the setting δ:=1.

Aspects of the disclosure relate to a skip level hypergraph. According to some embodiments, the hypergraph may be used in the construction of a range multi-map encryption scheme Ω_{R}. Some systems may use conventional hypergraph constructions that have undesirable trade-offs between communication complexity, update complexity, storage amplification and leakage, and they may be undesirable in certain settings because they result in encrypted range schemes that return false positives which violates certain engineering constraints.

Accordingly, to provide an improved hypergraph, provided herein is a hypergraph referred to as a skip level hypergraph. The skip level hypergraph may be compact, have good storage amplification and may provide no false positives. In particular, the skip level hypergraph may have storage amplification tuned by the sparsity factor and trimming factor parameters.

The skip level hypergraph may be appreciated by first describing a binary tree hypergraph used in some conventional systems. A binary tree hypergraph G_{2T}=(V, E) may be a hypergraph that underlies the encrypted range schemes of some conventional systems when viewed them as through the lens of the hypergraph compiler. Given a vertex set V={0, . . . , N−1}, where N is a power of 2 and n=log N, its hyperedges are defined as:

$$E = \{ {e}_{a , w} ⊆ V : w ∈ {\{ \frac{N}{{2}^{i}} \}}_{i ∈ \{ n \}} , a ∈ \{ z \cdot w : z ∈ [ \frac{N}{w} - 1 ] \} \} ,$$

where e_{a,w}={a, . . . , a+w−1}. This hypergraph may be viewed as a binary tree where the values in V correspond to the leaves and the edges e_{a,w} correspond to depth-I nodes of the tree. Given a range [a, b]⊆V, its min-cover may be computed as follows using the following algorithm, described here using the binary tree representation. First, compute the least common ancestor lca(a, b) of a and b. If all the values in [a, b] are leaves of the subtree rooted at lca(a, b), add lca(a, b) to the min-cover C★ and halt. If not, find the internal node c that is the rightmost child of lca(a, b)'s left child. Split the range into [a, c] and [c+1, b] and recur on both. Given a vertex vx, the edges that contain it can be recovered by returning the vertices along the path from vx to the root.

While this conventional hypergraph may be simple to implement, it has several limitations in practice that severely affect efficiency of the computer systems executing these processes. A range-to-point encoding step of the compiler may transform the (input) range multi-map into a point multi-map that stores a label/tuple pair per edge of the hypergraph and that each of these tuples is composed the tuples of the labels in that edge. From this, it can be seen how the number of edges, their size and the overlaps between edges influences the size of the resulting encrypted multi-map. The binary hypergraph may be O(log n), 1, log n, log n)-compact and, specifically, may result in schemes with storage overhead O(m·n·log n), where m is the size of the largest tuple in the range multi-map. For large domains, the log n multiplicative overhead is a practical issue.

Another limitation of the binary hypergraph may be that it leads encrypted range constructions with high contention in concurrent environments. In order to update the tuple of a range-level label [symbol] , one may be required to update the tuples of all the point-level labels/edges that contain it. Viewing the hypergraph as a binary tree, this may translate to updating the tuples of the edges/nodes on the path from the corresponding leaf to the root. Concurrent updates on a set of range-level labels [symbol] ₁, . . . , [symbol] ᵤ then may require locking every node on the leaf to root paths of these labels and since the root is on every such path, it may cause contention. Furthermore, since depth-1 nodes are on half the paths they are likely to cause contention, and since depth-2 nodes are on a quarter of the paths they are also likely (though less) to cause contention and so on.

To address these limitations the limitations of conventional hypergraphs, improved hypergraph which increases the computational efficiency of the computer system is provided. One example of such an improved hypergraph is a skip-level hypergraph G_{SKL}=(V, E_{s,t}), parameterized by a parameter s∈N≥1, the sparsity factor, and a parameter t, the trimming factor. Given a vertex set V={0, . . . , N−1}, where N is a power of 2 and n=log N, the edges of a skip-level hypergraph may be defined as:

$${E}_{s , t} = \{ {e}_{a , w} ⊆ V : S = \{ s \cdot q : q ∈ [ ⌊ \frac{t}{s} ⌋ , ⌊ \frac{n}{s} ⌋ ] \} ⋃ \{ n \} , w ∈ {\{ \frac{N}{{2}^{i}} \}}_{i ∈ S} , a ∈ \{ z \cdot w : z ∈ {[ \frac{N}{w} - 1 ]}_{0} \} \} ,$$

where 1≤s≤n, 0≤t≤└n┘ and [a, b]={a, a+1, . . . , b}. A sparsity factor of s forms the hypergraph to only consist of nodes at depths that are multiples of s. A trimming factor of t forms the hypergraph to only consist of the bottom n−t+1 depths. This hypergraph may have response amplification β=1, update amplification δ≤└n/s┘−└t/s┘+2 and storage amplification γ≤└n/s┘−└t/s┘+2. The storage amplification provides storage overhead of the resulting encryption range multi-map that is O(m·n·(└n/s┘−└t/s┘)). Minimum covers on GSKL may be computed using the algorithm described above and then removing edges/nodes at depths that are not multiples of s and that are lower than t. To maintain correctness, for every removed edge, a system may compute all of the hyperedges that constitute its children and that exist in the hyperedge set, as defined above. In some embodiments, the maximum number of hyperedges in a cover may be O((└n/s┘−└t/s┘)·2^{s}).

As discussed, a sparsity factor, trimming factor, and contention factors comprise parameters that define the structural properties of the range hypergraph. These parameters influence the efficiency of queryable encryption for ranges. Because each of these parameters may exclude nodes from the hypergraph, they may reduce competition between the remaining nodes. Reducing competition between nodes may increase the efficiency of the processing performed by the database system when using the hypergraph. Further, these parameters may affect the concurrency, storage, and communication overhead, as well as client-side computational complexity. According to some embodiments, a group of improved performance parameters may be selected to provide an improved efficiency profile. Such parameters may be selected based on evaluation across diverse client workloads with varying proportions of read and write operations. In some embodiments, a set of default values may be used to provide high performance across a wide range of client workloads. For example, a sparsity factor may be between 1 and 3 (e.g., 2), a trimming factor may be between 4 and 8 (e.g., 6), and a contention factor may be between 6 and 10 (e.g., 8).

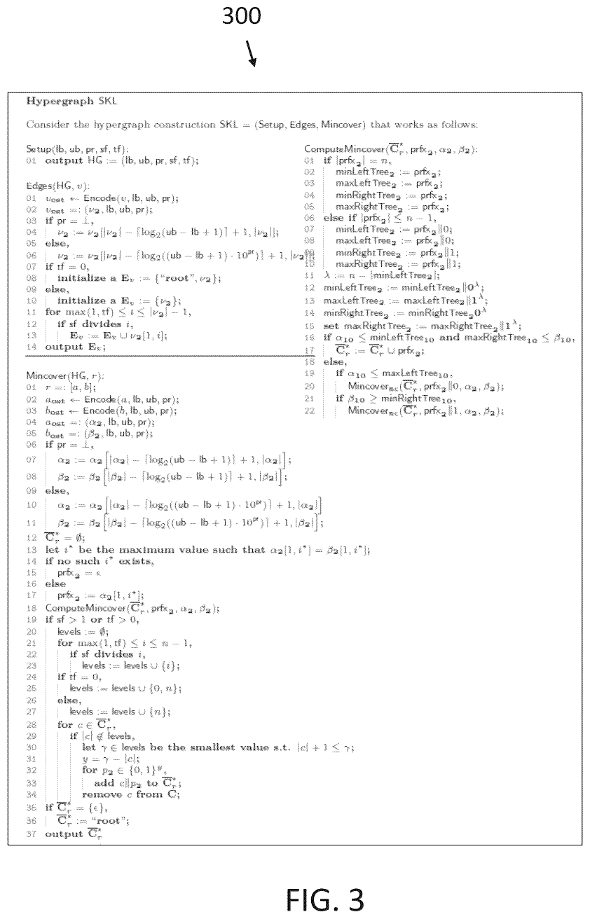

FIG. 3 shows exemplary pseudocode 300 for a hypergraph for database systems, according to some embodiments. The skip-level hypergraphs may be concretely structured using binary strings. For example, given a vertex set V={0, . . . , N−1}, an edge e_{a,w} can be represented as bit strings of length log N, where the 0-bit string is the empty string E. Furthermore, the min-cover and edges algorithms described above can be instantiated efficiently with this representation as described in FIG. 3.

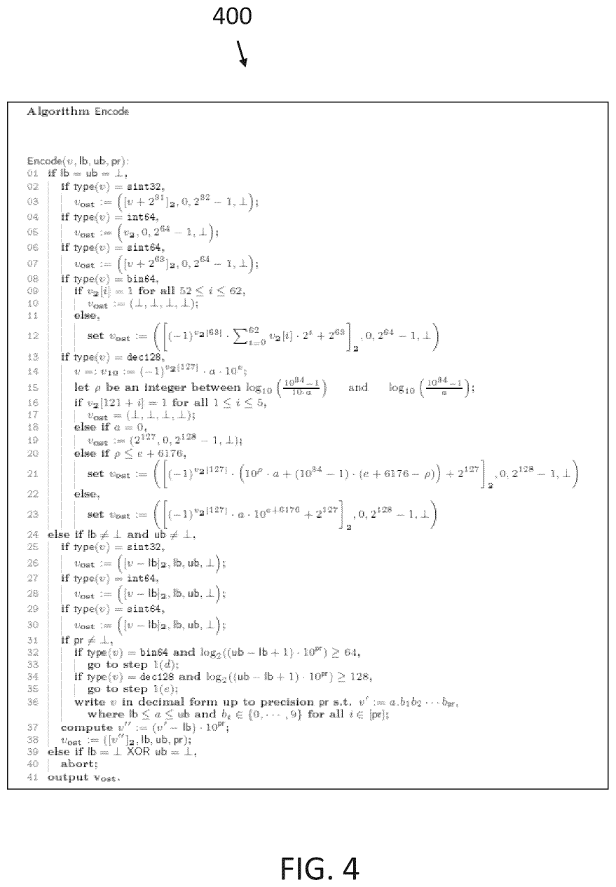

Aspects of the disclosure relate to numerical encodings. FIG. 4 shows exemplary pseudocode 400 for an encoding algorithm for database systems, according to some embodiments. According to some embodiments, hypergraph compilers may result in schemes that handle ranges over N. Some database systems such as MongoDB, however, may handle a variety of numerical types including signed integers, 64-bit integers, 64-bit signed integers and 64-bit floating point values. To handle this, numerical encodings are provided that map these types to N. The encodings are produced by a function Encode that outputs values in N with the following properties:
(order-preserving) given two numerical values v₁ and v₂ of the same numerical type, Encode outputs two natural numbers v₁′ and v₂′ that preserve the order of v₁ and v₂. In other words, if v₁<v₂ then v₁′<v₂′, if v₁=v₂ then v₁′=v₂′ and if v₁>v₂ then v₁′>v₂′.
(compactness) the encoding output by Encode is compact in the sense that it can be represented using the same number of bits as the original value.

An Encode function is now described in more detail. Encode may take as input a value v of some type, a lower bound lb, an upper bound ub and a precision pr and outputs an encoding v_{1:m} of v. The lower bound, upper bound and precision are parameters that can be used for optimization purposes if the ERMM may be used with labels within a domain [lb; ub] and that have precision pr. If the labels can come from the entire domain of the type and if they may be of any precision, then lb, ub and pr can be set to ⊥. The encoding v_{1:m} may be a triple that consists of a binary representation of a natural number, a lower bound, an upper bound and a precision.

In some embodiments, Encode may not output the encodings in decimal representation. In other words, given an input value v of some type, Encode: (1) encodes it as a natural number v′; and (2) outputs v′ in binary representation with the same number of bits as needed to represent v in its original numerical type. For example, the binary representation of a natural number a<2³² may be the unique sequence of bits (a₂[31], . . . , a₂[0]) such that:

$$a = {\sum }_{i = 0}^{31} {a}_{2} [ i ] \cdot {2}^{i} .$$

Encode may return v′ in binary representation because the Mincover and Edges algorithms operate on the binary representation of the values. Further details are provided. Encode may take as input the numerical value v, a lower bound lb, an upper bound ub, and a precision pr. If the lower and upper bound are not specified, i.e., lb=ub=⊥, there may be five cases depending on the numerical type:
if v is a signed integer (sint32), it adds 2³¹ to v and returns its binary representation along with an updated lower bound lb:=0, an updated upper bound ub:=2³²−1, and precision pr:=⊥. For example, it returns the tuple vₒₛₜ:=([v+2³¹]₂, 0, 2³²−1, ⊥). Notice that, here, every 32-bit signed integer is mapped to an integer between 0 and 2³²−1. Also, notice that because there are a total of 232 possible encoded values the Edges algorithm may output 33 edges (assuming the default sparsity).
if v is a 64-bit integer (int64), it returns the binary representation of v, with a lower bound lb:=0, an upper bound ub:=2⁶⁴−1, and precision pr:=⊥. More precisely, it returns the tuple vₒₛₜ:=(v2, 0, 2⁶⁴−1, ⊥). Note that the binary representation of v is 64 bits in length which means that the number of edges output by Edges (with default sparsity) is 65.
if v is a 64-bit signed integer (sint64), it adds 2⁶³ to v and returns its binary representation along with an updated lower bound lb:=0, an updated upper bound ub:=2⁶⁴−1 and precision pr:=⊥. More precisely, it returns the tuple vₒₛₜ:=([v+2⁶³]₂, 0, 2⁶⁴−1, ⊥), where [v+2⁶³]₂ is 64 bits in length.
if v is an IEEE 754 64-bit (double precision) floating point value (bin64), then Encode proceeds as follows. First, recall that the bin64 representation of v is a 64-bit string (v₂[63], . . . , v₂[0]) composed of three parts:
   v₂[63] is the sign bit,
   v₂[62, 52] is a sequence of 11 bits that encodes the exponent,
   v₂[51, 0] is a sequence of 52 bits that encodes the fraction.

Encode first checks that all the bits of the exponent are 1; if this is the case, it returns vₒₛₜ:=(⊥, ⊥, ⊥, ⊥) which means that v cannot be encoded for range search. Note that a value with an exponent of all 1's encodes NaN which OST does not support. Otherwise, Encode encodes v as the following natural number (represented here as a decimal):

$${v}_{10}^{′} := {v}_{2} [ 63 ] \cdot {\sum }_{i = 0}^{62} {v}_{2} [ i ] \cdot {2}^{i} + {2}^{63} ,$$

and generates its binary representation v₂′ which is 64 bits long. Finally, it returns v₂′, a lower bound lb:=0, an upper bound ub:=2⁶⁴−1, and precision pr:=1. Here v is a (double precision) floating point value represented as a binary string using the IEEE 754 standard, v₁₀′ is an encoding of v as a natural number (different than v) and v₂′ is the binary representation of v₁₀′
   if v is an IEEE 754 128-bit decimal floating point value (dec128), then Encode proceeds as follows. The dec128 representation of v is a 128-bit string that is interpreted in decimal as:

$${v}_{10} := {( - 1 )}^{{v}_{2} [ 127 ]} \cdot a \cdot {10}^{e} ,$$

where v₂[127] is the sign bit of v's dec128 representation, a∈{0, . . . , 10³⁴−1} and e∈{−6176, . . . , 6111}. Note that the pair (a, e) is not unique in the sense the there may be more than one pair that can be plugged into the equation above and result in the same decimal value v₁₀. For instance, for v₁₀=1000 both (10, 2) and (1, 3) are valid pairs since 1000=10·10²=1·10³. Encode chooses any such pair and finds the only integer ρ∈N that is between:

$${log}_{10} ( \frac{{10}^{34} - 1}{10 \cdot a} )$$

$$and$$

$${log}_{10} ( \frac{{10}^{34} - 1}{a} ) .$$

Encode then checks if the first five bits in the combination segment of the dec128 representation of v are all 1. More precisely, if for all 1≤i≤5, v₂[121+i]=1, then Encode returns (⊥, ⊥, ⊥, ⊥) which means that v cannot be encoded for range search. Otherwise, there are three cases depending on the value of a or how ρ compares to the exponent e:

$$- if a = 0 , then it sets {v}^{′} := {2}^{127} ;$$

$$- else if ρ \leq e + 6176 , it sets$$

$${v}^{′} := {( - 1 )}^{{v}_{2} [ 127 ]} \cdot ( {10}^{ρ} \cdot a + ( {10}^{34} - 1 ) \cdot ( e + 6167 - ρ ) ) + {2}^{127} ;$$

$$- else , it sets$$

$${v}^{′} := {( - 1 )}^{{v}_{2} [ 127 ]} \cdot a \cdot {10}^{e + 6176} + {2}^{127}$$

Finally Encode returns v₂′ which is the binary representation of v′, a lower bound lb:=0, an upper bound ub:=2¹²⁸−1, and precision pr:=1. Note that the binary representation of v′ may always be 128 bits long.

When the input lower and the upper bounds are specified (i.e., different from ⊥), then Encode works differently and as follows:
if v is either sint32, int64 or sint64, Encode returns the binary representation of v′:=v−lb, the same lower and upper bounds provided as input, and precision pr:=⊥. More precisely, it returns vₒₛₜ:=(v₂′, lb, ub, ⊥). Note that the binary representation of v₂′ may be 32, 64 and 64 bits long depending on whether v is sint32, int64 or sint64, respectively.
if the precision pr is set (i.e., different from ⊥), then Encode first checks if the numerical type of v is bin64 and if log₂((ub−lb+1)−10^{pr})≥64. If this is the case, then it returns the encoding, lower and upper bounds from the bin64 case above without lower and upper bounds. This is done because the given bounds along with the given precision would result in an encoding that is larger than the IEE 754 bin64 encoding. Similarly, if the numerical type of v is dec128 and log₂((ub−lb+1)·10^{pr})≥128, then Encode returns the encoding, lower and upper bounds from the dec128 case above without lower and upper bounds.

If the checks above fail, then it represents v in decimal form as follows:

$${v}^{′} := a \cdot {b}_{1} {b}_{2} ⋯ {b}_{pr} ,$$

where a is an integer such that lb≤a≤ub and, for all 1≤i≤pr, bi∈{0, . . . , 9}. Encode then sets v″:=(v′−lb)·10^{pr} and computes its binary representation. Here, the binary representation of v₂″ can be either 64 or 128 bits depending on the numerical type of v. Finally, it outputs v²″, the lower and upper bounds and the precision as given in the input.

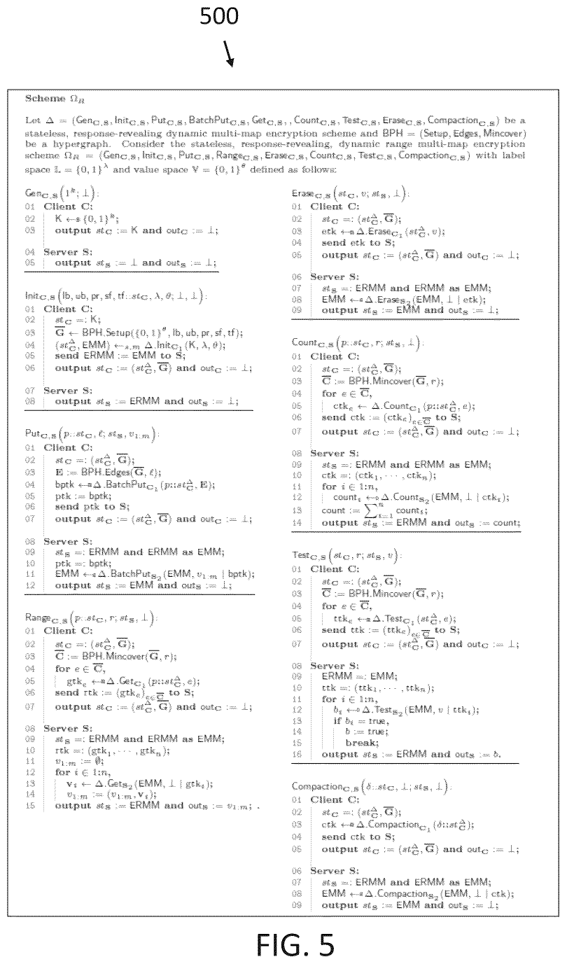

Aspects of the disclosure relate to an encrypted range multi-map. FIG. 5 shows exemplary pseudocode 500 for a range multi-map encryption scheme for database systems, according to some embodiments. One such encrypted range multi-map scheme is Ω_{R}, which is shown in FIG. 5. Ω_{R} makes use of the G_{SKL} hypergraph and, specifically, of its SKL implementation described in FIG. 3. In some embodiments, Ω_{R} also uses Δ=(GenC,S, InitC,S, PutC,S, BatchPutC,S, GetC,S, CountC,S, TestC,S, EraseC,S, CompactionC,S) which is a stateless, response-revealing dynamic multi-map encryption scheme.

In some embodiments, Ω_{R} differs from the schemes produced by the hypergraph compiler of conventional systems in the following ways. Ω_{R} may have additional operations. To be usable as a building block in OST, Ω_{R} may also handle Count and Test operations (similarly to Ω), where Count takes as input a range and outputs the number of values associated with labels within that range and Test takes as input a range from the client and a value from the server and returns true if there is a label within the range whose tuple includes the value.

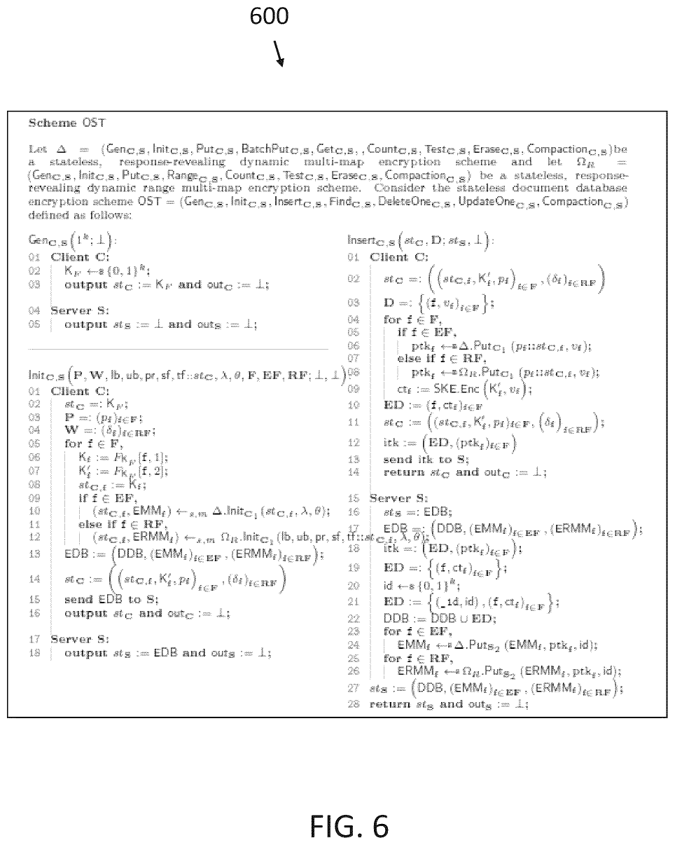

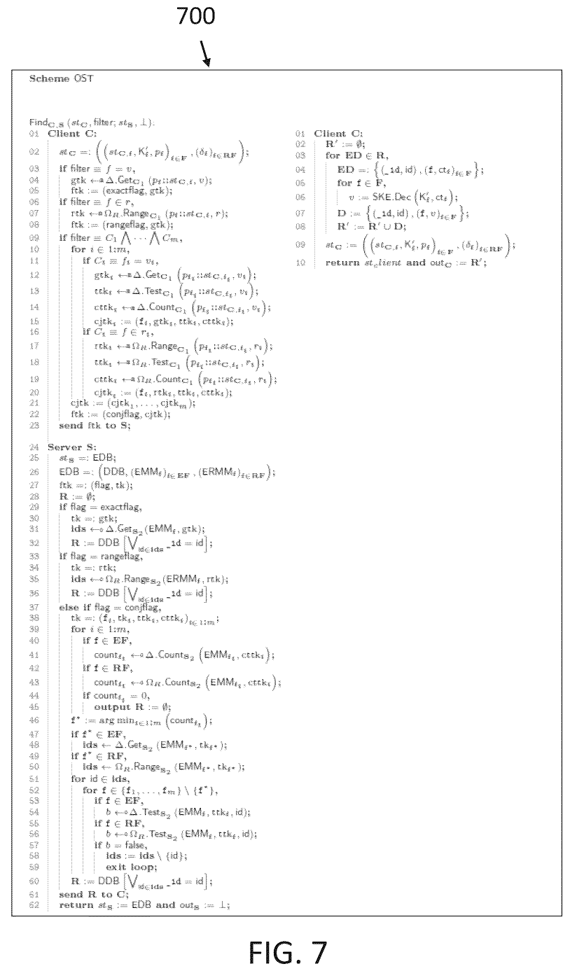

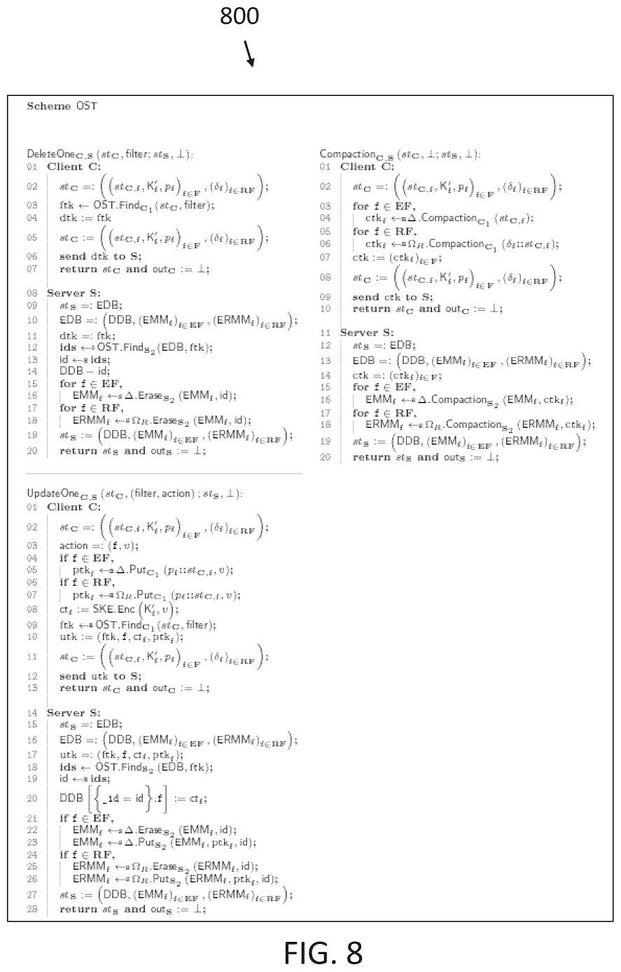

Aspects of the disclosure relate to a stateless encrypted document database. FIGS. 6, 7, and 8 respectively show exemplary pseudocode 600, exemplary pseudocode 700, and exemplary pseudocode 800 for a document database encryption scheme for database systems, according to some embodiments. For example, a document database encryption scheme OST is provided. OST may handle point and range queries. Pseudocode for OST is shown in FIGS. 6, 7, and 8. A high level description of OST is now provided.

OST may provide a stateless document database encryption scheme that makes use of Δ as a building block. In the description of OST below, the set of fields F contained in the database may be fixed and each field f∈F may have a contention factor pf∈N≥0.

Init. To initialize an encrypted document database Init starts by computing two keys Kf:=FKM[f, 1] and K′ f:=FKM[f, 2] for all fields f∈F. It then initializes an encrypted multi-map for the fields f∈F by computing (stC,f,EMMf)←Δ.InitC1 (Kf, θ) if f∈EF, and (stC,f,ERMMf)←ΩR.InitC1 (lb, ub, pr, sf, tf::stC,f, λ, θ) if f∈RF. It then initializes an empty database DDB and set EDB:=DDB, (EMMf)f∈EF, (ERMMf)f∈RF). The client sets the state as stC:=((stC,f,K′f, pf)f∈F, (δf)f∈RF) and sends EDB to S. Finally, the client outputs stC, whereas the server outputs EDB.

Insert. To insert a document D=:{(f, vf)f∈F}, the client computes an insertion token that is itself composed of an encrypted version of the document as well as token material to help the server update all the necessary encrypted structures. In particular, for all fields in f∈F, if f∈EF, the client computes ptkf←mΔ.PutC1 (pf::stC,f, vf); otherwise if f∈RF, it computes ptkf←mΩR.PutC1 (pf::stC,f, vf). It then encrypts the value of the field such that, ctf:=SKE.Enc (K′f, vf); and sets the encrypted document ED:=(f, ctf)f∈F. The client sets the state as stC:=((stC,f,K′f, pf)f∈F,(δf)f∈RF) and sends to the server the insert token itk:=(ED, (ptkf)f∈F). Given the insert token itk, the server first samples a document identifier uniformly at random id←$ {0, 1}k; and updates the encrypted document to have the following form ED:={(_id, id), (f, ctf)f∈F}. Second, the server updates all encrypted structures. First, for all exact fields f∈EF, it computes EMMf←sΔ.PutS2 (EMMf, ptkf, id); and for all range fields f∈RF, it computes ERMMf←sΩR.PutS2 (ERMMf, ptkf, id). The server finally outputs the updated encrypted database.

Find. To find the documents that match filter, the client does the following. If filter is an exact match filter, i.e., has the form f=v, it computes an Δ get token gtk←Δ.GetC1 (Kf, pf, v) and sends a find token ftk:=(exactflag, gtk) to the server. If filter is a range filter, i.e., it has the form f∈r, where r is a range, it computes an QR range token rtk←mΩR.RangeC1 (pf::stC,f, r) and sends a find token ftk:=(rangeflag, rtk) to the server. If filter is a conjunctive filter, i.e., has the form C1\hat{ } . . . \hat{ }Cm, where Ci≡fi=v₁ or Ci≡fi∈ri, it computes, for each clause Ci, three tokens. If Ci≡fi=vi, it computes gtki←Δ.GetC1 (Kfi), vi), ttki←Δ.TestC1 (Kf, vi) and cttki←Δ.countC1 (Kfi, vi) and sets cjtki:=(fi, gtki, ttki, cttki). If Ci≡fi∈ri, it computes rtki←mΩR.RangeC1 (pfi::stC,fi, ri), ttki←mΩR.TestC1 (pfi ::stC,fi, ri) and cttki←m ΩR. CountC1 (pfi ::stC,fi, ri), and sets cjtki:=(fi, rtki, ttki, cttki). Finally, the client sends ftk:=(conjflag, cjtk), where cjtk:=(cjtki)1≤i≤m to the server.

Given ftk, the server parses it as (flag, tk). If the find query is for an exact filter, i.e., if flag=exactflag, the server parses tk as gtk and recovers the IDs of the documents that match the filter by computing ids←Δ.GetS2 (EMMf, gtk). It then retrieves these documents from DDB and returns them to the client. If the find query is for a range filter, i.e., flag=rangeflag, the server parses tk as rtk and recovers the IDs of the documents that match the filter by computing ids←oΩR.RangeS2 (ERMMf, rtk). It then retrieves these documents from DDB and returns them to the client. If, on the other hand, filter=conjfilter the server parses tk as cjtki, for all 1≤i≤m. If the ith clause is for an exact filter, then it parses cjtki as (fi, gtki, ttki, cttki), computes the frequency of the field fi by computing counti←Δ.CountS2 (EMMfi, cttki). If the ith clause is for a range filter, then it parses cjtki as (fi, rtki, ttki, cttki), computes the frequency of the field fi by computing counti←Ωr.CountS2 (ERMMfi, cttki). If some counti=0, then returns Ø, otherwise it finds the field f★ with the smallest frequency and recovers the IDs of the documents that match f★'s clause by computing either ids←Δ.GetS2 (EMMf★, gtkf★), if f★∈EF, or ids←ΩR.RangeS2 (EMMf*, rtkf*), if RF. Then, for all _id∈ids, it tests if _id is in the result set of the non-f★ clauses by computing b←Δ.TestS2 (EMMf, ttkf, _id) for exact fields and b←oΩR.TestS2 (EMMf, ttkf, id) for range fields. If this is not the case, i.e., if b=0, then _id is removed from ids. The documents with document IDs in ids are then retrieved from DDB and returned to the client who decrypts the ciphertexts associated to each field f using the key K′f.

DeleteOne. To delete one document that matches a filter of filter, the client sends a OST find token ftk←OST.FindC1 (stC, filter) to the server, who uses it to recover the IDs of the documents that match the filter by computing ids←Δ.FindS2 (EDB, ftk). The server then selects a document ID uniformly at random from ids such that id←$ ids. Finally, the server erases _id from all the encrypted multi-maps; that is, for all f∈F, it computes EMMf←Δ.EraseS2 (EMMf, _id) for exact fields and ERMMf←ΩR.EraseS2 (ERMMf, _id) for range fields.

UpdateOne. To update one document that matches a filter of filter with an action of action=(f, v), the server will need to: (1) pick a document uniformly at random from the set of documents that match the filter; (2) replace the content of field f with an encryption of the new value v; (3) remove id from EMMf; and (4) put id in v's tuple in EMMf or ERMMf depending on whether the type of the field. To enable this, the client sends to the server an update token

$$utk := ( ftk , f , {ct}_{f} , {ptk}_{f} ) ,$$

where ftk←OST.FindSs (EDB, filter) is an OST find token for filter, ctf:=SKE.Enc(K f, v) is an encryption of v, and ptk←Δ.PutC1 (Kf, pf, v) is an Δ put token for v if f∈EF, or ptkf←mΩR.PutC1 (pf::stC,f, v) if f∈RF. The server uses the find token ftk to recover the IDs of the documents that match the filter by computing ids←Δ.FindS2 (EDB, ftk). The server then selects a document ID uniformly at random from ids such that id←$ ids, and it performs the following. It updates the content of the field f of document DDB[id=id] with the new encrypted value ctf; it erases _id from the EMMf by computing EMMf←Δ.EraseS2 (EMMf, _id) if f∈EF, or ERMMf←sΩR.EraseS2 (ERMMf, id) if f∈RF; and puts the new value in EMMf by computing EMMf←Δ.PutS2 (EMMf, ptkf, id) if f∈EF, or ERMMf←sΩR.PutS2 (ERMMf, ptkf, id) if f∈RF. Finally, the server outputs the updated encrypted document database EDB.

Compaction. To compact, the client sends an Ω compaction token for every field f∈F. That is, it sends ctk:=(ctkf)f∈F, where ctkf←Δ.CompactionC1 (Kf) if f∈EF, and ctkf←mΩR.CompactionC1 (δf::stC,f) if f∈RF. Given ctk, the server simply compacts the encrypted multi-map EMMf of all exact fields and ERMMf of all range fields.

Aspects of the disclosure relate to a hypergraph compiler. An encrypted range multi-map construction QR may be based on a hypergraph compiler described below. A focus of the system may be on sub-linear solutions. Accordingly, an approach described herein may define a data structure that handles range queries and then design an STE scheme for that particular data structure. More precisely, the structures we use are called range multi-maps (RMM). As their name suggests, these are extensions of multi-maps that handle range queries.

In some embodiments, the approach consists of first transforming an RMM into a standard multi-map—standard in the sense that it does not support range queries and then encrypting it with a standard multi-map encryption scheme. The systems described herein may vary from other approaches in how transformations work. For example, in this framework, the RMM-to-MM transformation may be determined by a hypergraph defined on the domain of the RMM. A large number of RMM-to-MM transformations may be generated by using different hypergraphs. The compiler makes black-box use of a range hypergraph and of a response-hiding multi-map encryption scheme and proceeds in two steps. At a high-level, it first uses the range hypergraph to transform the range multi-map into a standard multi-map. It then encrypts the multi-map with a response-hiding multi-map encryption scheme. To search for a range r=[a, b], the client finds rs minimum cover with respect to the range hypergraph and generates get tokens for each edge in the cover. To respond, the server just queries the encrypted multi-map on each get token and returns the responses. More precisely, the resulting range multi-map encryption scheme makes black-box use of a dynamic response-hiding multi-map encryption scheme ΣMM=(Init, GetToken, Get, PutToken, Put, DelToken, Delete) and of a hypergraph scheme GH=(SetupH, EH, MincoverH).

Setup. The Setup algorithm takes as input a security parameter k and a range multi-map RMM. It first uses SetupH to construct a range hypergraph H=(L,E) over the label space L of RMM. Specifically, it runs SetupH on L to compute a set of edges E⊆P(L) and a succinct representation stH of H. Setup then constructs a multi-map MMH that maps each edge (identifier) e∈E to the values associated with the labels in e. Throughout, this multi-map may be referred to as the hyper multi-map. That is, for all e∈E, MMH maps the edge e to a tuple of values te defined as

$${t}_{e} = {( RMM [ ℓ ] )}_{ℓ ∈ {𝕃}_{RMM} ⋂ ∈} .$$

Note that a plaintext range query r can now be answered by first finding the minimum cover Mr and querying MMH on the identifiers of the edges e∈Mr. It then encrypts MMH with ΣMM and returns the resulting key K as its own key and the resulting encrypted multi-map ΣMM as the encrypted range multi-map. More precisely, it outputs K, st=stH and ERMM=ΣMM.

Range token. The RangeToken algorithm takes as input a secret key K, a state st and a range query r=[a, b]. It uses MincoverH to compute the minimum cover Mr of the range query and, for each edge e EMr, computes a get token gtke using ΣMM.GetToken. It then outputs a range token rtk=(gtke)e∈Mr.

Ranges. The Range algorithm takes as input an encrypted range multi-map ERMM=EMM and a range token rtk parsed as (tke)e∈Mr. It then uses ΣMM.Get to query EMM on each of the sub-tokens in rtk and outputs the union of the results.

Put token. The PutToken algorithm takes as input a secret key K, a state st and a new label/tuple pair ( [symbol] , v1:m). It first uses EH to find the set of edges E [symbol] in H that contain [symbol] . For all e∈E [symbol] , it uses ΣMM.PutToken to create a put token ptk′ e. It then outputs a put token ptk=(ptk′e)e∈E [symbol] .

Put. The Put algorithm takes as input the encrypted range multi-map ERMM=EMM and a put token ptk. It first parses the put token as a tuple of sub-tokens (ptk′e)e∈E [symbol] . It then uses ΣMM.Put to apply each of the sub-tokens to the encrypted multi-map. Finally, it outputs the updated encrypted multi-map.

Application Ser. No. 18/321,721, filed May 22, 2023, and entitled “SYSTEMS AND METHODS FOR CLIENT-SIDE AND FIELD-LEVEL ENCRYPTION WITH DYNAMIC SCHEMA DATABASES,” is hereby incorporated herein by reference in its entirety. Application Ser. No. 18/075,873, filed Dec. 6, 2022, and entitled “SYSTEMS AND METHODS FOR HIDING RESPONSE VOLUME WITH ENCRYPTED MULTI-MAPS,” is hereby incorporated herein by reference in its entirety. Application Ser. No. 17/570,730, filed Jan. 7, 2022, and entitled “SYSTEMS AND METHODS USING EMULATION FOR END TO END ENCRYPTION,” is hereby incorporated herein by reference in its entirety. Application Ser. No. 17/563,425, filed Dec. 28, 2021, and entitled “SYSTEMS AND METHODS USING EMULATION FOR END TO END ENCRYPTION,” is hereby incorporated herein by reference in its entirety. Application Ser. No. 18/328,867, filed Jun. 5, 2023, and entitled “SYSTEMS AND METHODS FOR END-TO END-ENCRYPTION WITH ENCRYPTED MULTI-MAPS,” is hereby incorporated herein by reference in its entirety. Application Ser. No. 18/328,878, filed Jun. 5, 2023, and entitled “SYSTEMS AND METHODS FOR END-TO END-ENCRYPTION WITH ENCRYPTED MULTI-MAPS,” is hereby incorporated herein by reference in its entirety. Application Ser. No. 18/328,907, filed Jun. 5, 2023, and entitled “SYSTEMS AND METHODS FOR END-TO END-ENCRYPTION WITH ENCRYPTED MULTI-MAPS,” is hereby incorporated herein by reference in its entirety.

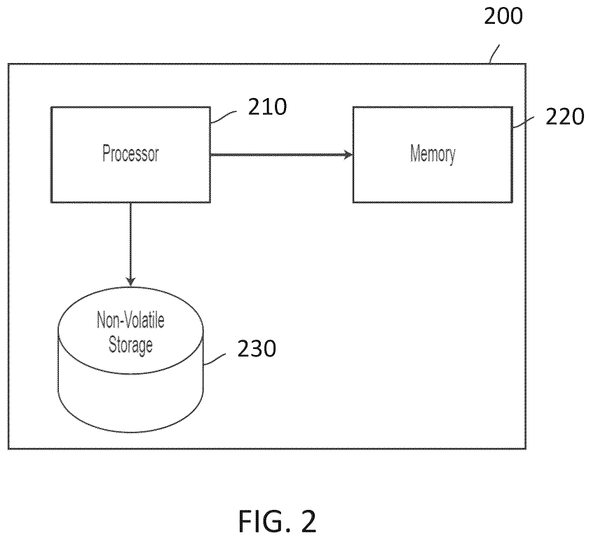

An illustrative implementation of a computer system 200 that may be used in connection with any of the embodiments of the disclosure provided herein is shown in FIG. 2. The computer system 200 may include one or more processors 210 and one or more articles of manufacture that comprise non-transitory computer-readable storage media (e.g., memory 220 and one or more non-volatile storage media 230). The processor 210 may control writing data to and reading data from the memory 220 and the non-volatile storage device 230 in any suitable manner. To perform any of the functionality described herein, the processor 210 may execute one or more processor-executable instructions stored in one or more non-transitory computer-readable storage media (e.g., the memory 220), which may serve as non-transitory computer-readable storage media storing processor-executable instructions for execution by the processor 210. Methods described herein (such as managing database clients and distributed databases) may be implemented on computer systems like computer system 200.

It should be appreciated that various examples above each describe functions that can be and have been incorporated in different system embodiments together. The examples and described functions are not exclusive and can be used together. Modifications and variations of the discussed embodiments will be apparent to those of ordinary skill in the art and all such modifications and variations are included within the scope of the appended claims.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described with reference to figures and functions above, the various system components, analysis algorithms, processing algorithms, etc.) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing,” “involving,” and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A database system comprising:
at least one processor operatively connected to a memory, the at least one processor when executing configured to:
manage a database client, the database client configured to:
accept a range query;
convert the range query into one or more equality queries; and
transmit the one or more equality queries to a distributed database; and
manage the distributed database, the distributed database configured to:
store encryption of plaintext data;
process the one or more equality queries against the encryption of the plaintext data, such that the one or more equality queries operate on encrypted data;
retrieve the encrypted data; and
provide a result of the range query to the database client, wherein:
the database client is configured to convert the range query into the one or more equality queries by compactly mapping input numerical data having any numerical data type supported by the distributed database to output positive integers with order preserved relative to the input numerical data; and
converting the range query into the one or more equality queries comprises converting the range query into the one or more equality queries using a range hypergraph arranged with at least one of a sparsity factor or a trimming factor.

2. The database system of claim 1, wherein:
converting the range query into the one or more equality queries comprises:
in response to determining that the input numerical data has a data type other than a first data type, encoding the input numerical data as data of the first data type; and
transforming the encoded data of the first data type into the one or more equality queries, the one or more equality queries representative of the input numerical data.

3. The database system of claim 1, wherein:
the range hypergraph comprises a skip level hypergraph including a first plurality of nodes and excluding a second plurality of nodes;
the included first plurality of nodes of the skip level hypergraph are arranged by the at least one of the sparsity factor or the trimming factor.

4. The database system of claim 3, wherein:
the skip level hypergraph is arranged with the sparsity factor and the trimming factor; and
the included first plurality of nodes of the skip level hypergraph comprises nodes of depths that are:
multiples of the sparsity factor; and
bottom depths defined by the trimming factor.

5. The database system of claim 3, wherein:
including the first plurality of nodes and excluding the second plurality of nodes in the skip level hypergraph reduces competition between nodes in the skip level hypergraph.

6. The database system of claim 1, wherein:
storing the encryption of the plaintext data comprises performing a compaction protocol on the stored encryption of the plaintext data; and
performing the compaction protocol comprises padding an input with dummy data.

7. The database system of claim 6, wherein:
padding the input with the dummy data is configured to reduce leakage for range queries.

8. At least one non-transitory computer-readable storage medium having instructions encoded thereon that, when executed by at least one processor, cause the at least one processor to perform a method for managing a database system, the method comprising:
managing a database client, comprising:
accepting a range query;
converting the range query into one or more equality queries; and
transmitting the one or more equality queries to a distributed database; and
managing the distributed database, comprising:
storing encryption of plaintext data;
processing the one or more equality queries against the encryption of the plaintext data, such that the one or more equality queries operate on encrypted data;
retrieving the encrypted data; and
providing a result of the range query to the database client, wherein:
converting the range query into the one or more equality queries comprises compactly mapping input numerical data having any numerical data type supported by the distributed database to output positive integers with order preserved relative to the input numerical data; and
converting the range query into the one or more equality queries comprises converting the range query into the one or more equality queries using a range hypergraph arranged with at least one of a sparsity factor or a trimming factor.

9. The at least one non-transitory computer-readable storage medium of claim 8, wherein:
converting the range query into the one or more equality queries comprises:
in response to determining that the input numerical data has a data type other than a first data type, encoding the input numerical data as data of the first data type; and
transforming the encoded data of the first data type into the one or more equality queries, the one or more equality queries representative of the input numerical data.

10. The at least one non-transitory computer-readable storage medium of claim 8, wherein:
the range hypergraph comprises a skip level hypergraph including a first plurality of nodes and excluding a second plurality of nodes;
the included first plurality of nodes of the skip level hypergraph are arranged by the at least one of the sparsity factor or the trimming factor.

11. The at least one non-transitory computer-readable storage medium of claim 10, wherein:
the skip level hypergraph is arranged with the sparsity factor and the trimming factor; and
the included first plurality of nodes of the skip level hypergraph comprises nodes of depths that are:
multiples of the sparsity factor; and
bottom depths defined by the trimming factor.

12. The at least one non-transitory computer-readable storage medium of claim 10, wherein:
including the first plurality of nodes and excluding the second plurality of nodes in the skip level hypergraph reduces competition between nodes in the skip level hypergraph.

13. The at least one non-transitory computer-readable storage medium of claim 8, wherein:
storing the encryption of the plaintext data comprises performing a compaction protocol on the stored encryption of the plaintext data; and
performing the compaction protocol comprises padding an input with dummy data.

14. The at least one non-transitory computer-readable storage medium of claim 13, wherein:
padding the input with the dummy data is configured to reduce leakage for range queries.

15. A computer-implemented method for managing a database system, the method comprising:
managing a database client, comprising:
accepting a range query;
converting the range query into one or more equality queries; and
transmitting the one or more equality queries to a distributed database; and
managing the distributed database, comprising:
storing encryption of plaintext data;
processing the one or more equality queries against the encryption of the plaintext data, such that the one or more equality queries operate on encrypted data;
retrieving the encrypted data; and
providing a result of the range query to the database client,
converting the range query into the one or more equality queries comprises compactly mapping input numerical data having any numerical data type supported by the distributed database to output positive integers with order preserved relative to the input numerical data; and
converting the range query into the one or more equality queries comprises converting the range query into the one or more equality queries using a range hypergraph arranged with at least one of a sparsity factor or a trimming factor.

16. The computer-implemented method of claim 15, wherein:
converting the range query into the one or more equality queries comprises:
in response to determining that the input numerical data has a data type other than a first data type, encoding the input numerical data as data of the first data type; and
transforming the encoded data of the first data type into the one or more equality queries, the one or more equality queries representative of the input numerical data.

17. The computer-implemented method of claim 15, wherein:
the range hypergraph comprises a skip level hypergraph including a first plurality of nodes and excluding a second plurality of nodes;
the included first plurality of nodes of the skip level hypergraph are arranged by the at least one of the sparsity factor or the trimming factor.

18. The computer-implemented method of claim 17, wherein:
the skip level hypergraph is arranged with the sparsity factor and the trimming factor; and
the included first plurality of nodes of the skip level hypergraph comprises nodes of depths that are:
multiples of the sparsity factor; and
bottom depths defined by the trimming factor.

19. The computer-implemented method of claim 15, wherein:
storing the encryption of the plaintext data comprises performing a compaction protocol on the stored encryption of the plaintext data; and
performing the compaction protocol comprises padding an input with dummy data.

20. The computer-implemented method of claim 19, wherein:
padding the input with the dummy data is configured to reduce leakage for range queries.
